(19) United States
(12) Patent Application Publication
(10) Pub. No.: US 2012/0109981 A1
(43) Pub. Date: May 3, 2012

(54) GENERATING PROGRESSIVE QUERY RESULTS

(76) Inventors: Goetz Graefe, Madison, WI (US); Harumi Kuno, Cupertino, CA (US)

(21) Appl. No.: 12/914,299

(22) Filed: Oct. 28, 2010

(51) Int. Cl. G06F 17/30

(52) U.S. Cl. 707/752; 707/E17.044

(57) ABSTRACT

There is provided a method for generating results for a sort operation. The method includes writing a subset of input to memory. The subset may be sorted based on the sort operation. The sorted subset may be compared to previous results. The previous results may be recalled from a client of the sort operation based on the comparison.

### BACKGROUND

Many organizations place a priority on data, such as business data. Businesses typically have complex decision making apparatus, e.g., information technology, that process large volumes of the business data. These processes load, store, and report on the data in processes that normally take place offline. The amount of time spent processing and analyzing this data may take place overnight, or even over the course of weeks.

For example, cash register transactions may be analyzed for marketing data. A significant amount of time may pass before a collection of cash register transactions is stored, analyzed, or reported.

As such, organizations typically wait a significant amount time before being able to make informed decisions. The value of decisions made accordingly may be diminished by data whose relevance is diminished with time. More relevant data may be provided by reducing the amount of time between the data is relevant, and when the data is analyzed or reported on.

### BRIEF DESCRIPTION OF THE DRAWINGS

Certain embodiments are described in the following detailed description and in reference to the drawings, in which:

FIG. 1A is a process flow diagram showing a computer-implemented method for generating sort results during run generation according to an embodiment;

FIG. 1B is a process flow diagram showing a computer-implemented method for generating sort results during run merging according to an embodiment;

FIG. 2 is a block diagram showing data flow according to an embodiment;

FIG. 3 is a Venn diagram showing overlapping data sets A, B, and C for binary matching operations according to an embodiment;

FIG. 4 is a block diagram of a system adapted to generate query results according to an embodiment; and

FIG. 5 is a block diagram showing a system with a non-transitory, machine-readable medium that stores code adapted to query data streams according to an embodiment.

### DETAILED DESCRIPTION

One way to provide relevant results to streaming applications is to make initial query results available before the query finishes. Initial query results may then be streamed to subsequent operations or applications.

In database query processing, some algorithms naturally deliver their first results immediately, e.g., a selection that simply applies a filter to each input item. Other operations, e.g., top, cannot naturally deliver their first results immediately because results are not available until all the input data is processed.

The top operation may specify a sort order and the number of top values, N, desired in the output. For example, a top operation may specify a descending sort order and 5 top values. The results of such an operation may include the top 5 revenue producers in an organization.

In some circumstances, more tuples may result than the number, N, specified. In general, if input values are not unique or of variable-size, the size of the final output may differ than the specified number, N. For example, if input values are not unique, the output might be larger than the specified size. This concept is similar to the process for awarding medals at the Olympics. If two top athletes achieve precisely the same score, four medals may be awarded instead of three, e.g., two gold, and one each of silver and bronze.

Typically, one of the following three algorithms may be used to implement the top operation. First, if the final output fits in memory, each tuple in the input may be compared with the top entry processed so far. This algorithm may keep the N top, e.g., smallest, values seen so far in a priority queue, sorted according to the specified sort order.

Second, if all the input does not fit in memory, all input may be sorted using a standard external merge sort algorithm. The smallest N items may be produced during a final merge step. After the smallest N items are identified, the merge step and the sort operation may be aborted.

A third algorithm includes some modifications of external sorting. In particular, a queue employed for run generation (described below), may ensure that many tuples of the input need not be written to runs during the external merge sort. However, all three traditional algorithms may consume their entire input before producing results.

The top operation is typically implemented with algorithms that consume their entire input before producing results. Other operations, e.g, sort and join, are similarly implemented.

Traditional sorting produces output only after consuming all input and after performing all intermediate merge steps. For example, an external merge sort may produce its first output only during its final merge step.

The traditional join algorithms are nested loops join, merge join, and hash join. Nested loops join may be inefficient unless a pre-existing index on an “inner” input is available along with its join column. The merge join algorithm may perform a costly sort unless the join column of each input is already in sort order.

With the hash join, if one of the inputs does not fit in memory, a computationally expensive overflow condition may result. In the overflow condition, all inputs of the join may be written to temporary disk space. As such, the hash join executes two instances of external partition sort with interleaved schedules.

The index nested loops join permits streaming the outer input if the inner input is static and indexed. However, if both inputs are indexed, the inner and outer input can switch roles.

In other words, data from one input is joined while the data from the other input is held static for a short period. If the outer input is sorted prior to index searches, the sort operation may become a blocking operation, preventing the reporting of early results.

The symmetric hash join is very similar, with an in-memory hash table for each input serving the role of an index in an index nested loops join. If memory is insufficient to hold both hash tables, hash table overflow is applied to both inputs and both hash tables.

The merge join readily may produce early results if both inputs are pre-sorted for the join operation. However, producing early results may be very complex if there are variable input delivery rates. Alternatively, dynamic memory allocation may also impede the production of early results.

In various embodiments, progressive operators for the top, sort, and join operations may provide early results to streaming applications. In addition to inner joins, other types of joins may be used to generate early results, as well as binary set operations. Using the progressive operators may provide the early results before the query producing those results finishes.

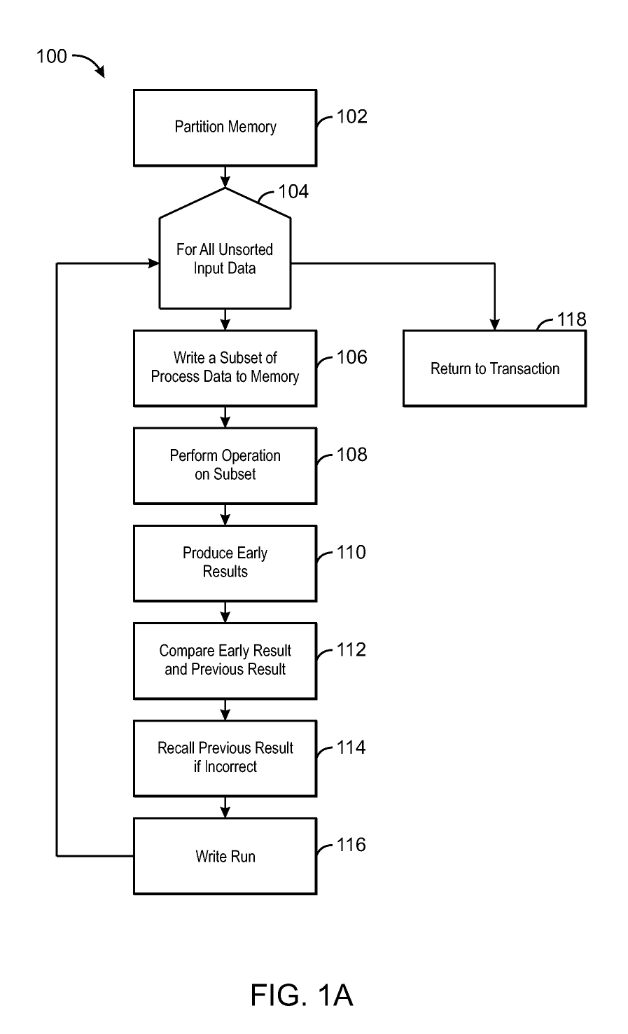

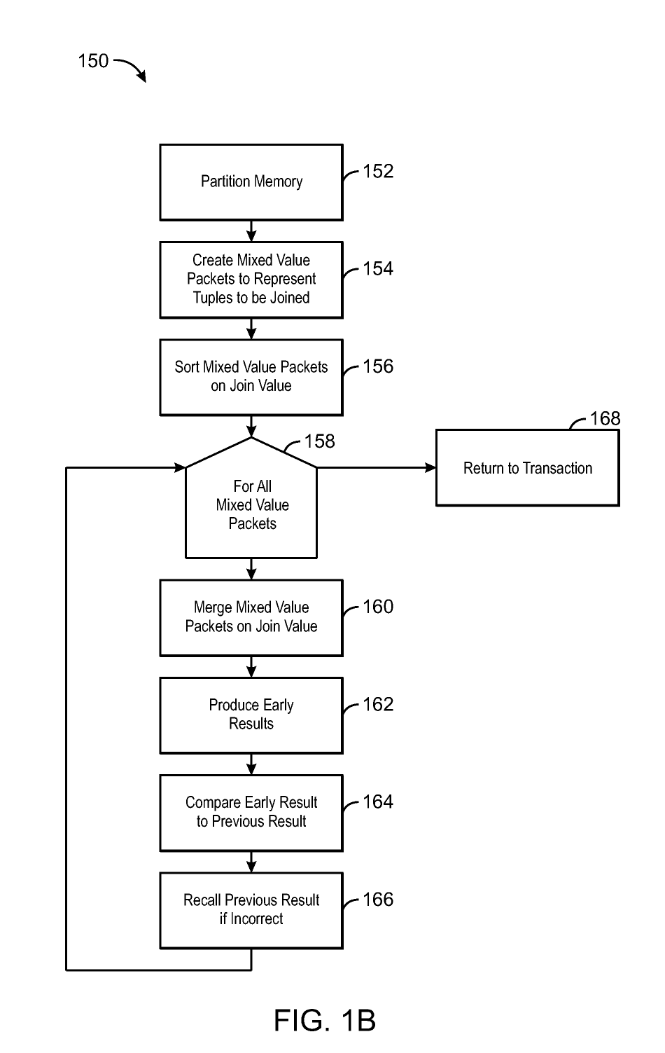

FIG. 1A is a process flow diagram showing a computer-implemented method 100 for generating sort results during run generation according to an embodiment. It should be understood that the process flow diagram is not intended to indicate a particular order of execution.

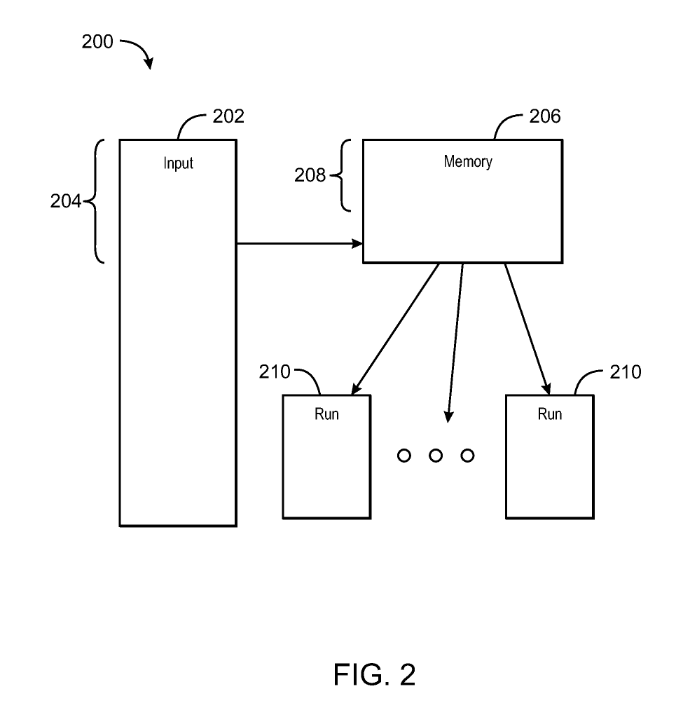

For the sake of clarity, the method 100 is described with reference to FIG. 2, which is a block diagram 200 showing data flow according to an embodiment. The block diagram 200 shows an input 202, memory 206, and runs 210.

Typically, a query generates results by processing the input 202. The input 202 may include a number of tuples that are to be processed based on specifications in the query. The specifications may include operations, aggregations, user defined functions, predicates, and the like. The memory 206 may be random access memory, a cache, or any other memory that a database execution engine (engine) uses for fast performance data access.

The method 100 begins at block 102, when the engine partitions the memory 206. The memory 206 may be partitioned to include a priority queue 208, described in greater detail below.

Blocks 104-116 may be performed for all the unsorted input 202. Because the input 202 may be too large to fit into memory 206, the input 202 may be processed in batches, e.g., subsets 204. Accordingly, at block 106, the engine may write a subset 204 to memory 206.

At block 108, the engine may perform an operation on the subset 204. The operation may be specified in a query plan for the query. Operations may include top, sort, and join operations.

At block 110, an early result may be produced. In one embodiment, the early result may be written to the priority queue 208. In an embodiment similar to the first traditional top algorithm, the priority queue 208 holds the N smallest values seen so far.

At block 112, the early result may be compared to a previous result. An input item smaller than the largest among the N smallest seen so far may replace a value from the priority queue 208. Accordingly, at block 114, the previous result may be recalled if incorrect. More specifically, the replaced item may be recalled from the output, and replaced with the new value.

At block 116, a run may be written from the memory 206 to disk. Each subset 204 may be written to memory 206, processed, and then written to disk. The subsets 204 written to disk are referred to herein as runs 210. As shown, processing of the input 202 may result in multiple runs 210 being written to disk.

It should be noted that disk is merely an example of one possible destination for the run 210. Other storage with lesser performance characteristics than the memory 204 may also be used.

The next subset 204 of the input 202 may then be processed in blocks 104-116. In some embodiments, the early result may be made available to a client after a predetermined number of iterations of blocks 104-116.

After run generation, a run merge may be performed. The run merge may compare the results in each run against each other to generate a final result.

FIG. 1B is a process flow diagram showing a computer-implemented method 150 for generating sort results during run merging according to an embodiment. It should be understood that the process flow diagram is not intended to indicate a particular order of execution.

The method 150 begins at block 152, where the memory 206 may be partitioned. At block 154, mixed value packets may be created to represent tuples joined according to the sort operation. At block 156, the mixed value packets may be sorted on a join value. In one embodiment, an early result may be produced from the sort.

Blocks 158-166 may then be repeated for each mixed value packet. At block 160, matching mixed value packets may be merged. The merge may result in a single mixed value packet for each distinct join key value. When the merge comes across two mixed value packets that match, the two mixed value packets may be merged.

At block 162, an early result may be produced. At block 164, the early result may be compared to a previous result. At block 166, the previous result may be recalled, if the previous result is incorrect. At the conclusion of the merge, at block 168, control may be returned to the transaction executing the query.

In one embodiment, excessive recall traffic may be avoided by consuming some substantial amount of input, then producing the current contents of the priority queue as initial output, and subsequently uses the recall logic described above. For example, the priority queue and the previous result may only be compared periodically.

Yet another embodiment reduces traffic for recalling and replacing earlier output by forming batches of recalls and replacements. Batches might be initiated by the number of replacement or by the difference in replaced and replacing tuples.

With regard to a sorting operation, one embodiment may combine a “top” algorithm with a traditional sort algorithm, e.g., external merge sort. In such an embodiment, the first N values in the final output may be produced by a “top” operation, the remaining output values may be produced by a standard external merge sort.

During run generation, the memory 206 may be split between the priority queue 208 for the “top” operation and a workspace for run generation. Run generation may use the priority queue 208, quicksort, or any other suitable algorithm. When a tuple is to be replaced in the priority queue 208 by the “top” operation, the replaced tuple may be inserted into the standard sort algorithm. The results of the top operation may be produced as initial output after consuming the last input value or, using the progressive “top” described above, even earlier.

With regard to join operations, some embodiments may include a merge join algorithm that reduces the join of two unsorted inputs to an aggregation operation. As such, the merge join may performs the aggregation operation using sorting, and exploits logic similar to early duplicate elimination for early delivery of output values.

A value packet is a set of records with the same key value, e.g., the join column. Additionally, the set of records is contiguous in a file or stream.

A value packet is often processed in its entirety rather than one tuple at a time. Value packets do not require a special data structure. Rather, multiple consecutive records with the same key value are all that is required.

Merged indexes interleave records from multiple sources in a single B-tree structure. Records in merged indexes interleave field values with tags that define fields and their types. A data stream with multiple record types is referred to herein as a “mixed stream.”

Additionally, a value packet within such a stream is referred to as a “mixed value packet.” A mixed value packet may be a data structure that uniformly represents tuples from multiple data sources. In one embodiment, the tuples may be heterogeneous.

Reducing a join operation to an aggregation operation may advantageously use aspects of value packets and merged indexes. Both (or all) join inputs may be sorted as a single data set in a single sort operation.

Individual tuples may contain tags indicating their type and source, i.e., the join input from where record originated. Tuples with matching join values may form value packets during the sort operation.

Each time tuples meet up to form a larger value packet, the join logic may produce output records. For example, in a join of two inputs, two value packets might each contain some tuples from each input. If the join inputs are designated as A and B and the value packets as P and Q, combining P and Q into a single value packets may join the A tuples in P with the B tuples in Q as well as the A tuples in Q with the B tuples in P.

The tuples thus produced may be part of the final join output. Since the sort operation forms a single value packet for each distinct value in the join key, any record in the correct join output is eventually produced. Moreover, since any specific pair of matching A and B records may be merged into the same value packet only once. No join output record may be produced twice.

The join logic may be applied after the sort operation, i.e., during the final merge step in an external merge sort. Alternatively, the join logic may be applied each time two value packets are merged. In such a case, output may be produced incrementally, as in a progressive merge join.

Run generation may produce early output either while sorting or while saving the runs. If run generation employs mini-runs in memory (based on input pages or on a CPU cache) and merges mini-runs to form initial on-disk runs, this merge operation may produce early output.

Some embodiment may use inputs of different sizes, with inputs arriving in an interleaved schedule or in bursts, with skew in the key value distribution, with duplicate key values in one or both inputs, etc. In such embodiments, a sort algorithm may be improved, e.g., modifications made to enable dynamic memory allocation and thus to simplify workload management.

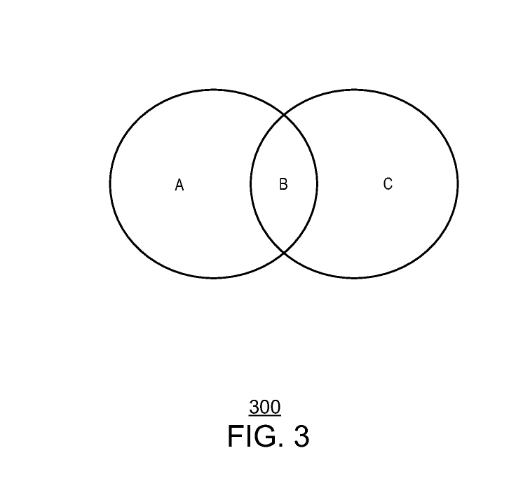

In addition to top, sort, and join operations, binary set operations may be used to generate early results. Using progressive operators may provide the early results before the query producing those results finishes. FIG. 3 is a Venn diagram showing overlapping data sets A, B, and C for binary matching operations according to an embodiment. TABLE 1 illustrates the wide range of binary matching operations that can be reduced to aggregation just like an inner join.

TABLE 1

| | MATCH ALL | MATCH SOME |
|---|---|---|
| OUTPUT | ATTRIBUTES | ATTRIBUTES |
| A | DIFFERENCE | ANTI-SEMI-JOIN |
| B | INTERSECTION | JOIN, SEMI-JOIN |
| C | DIFFERENCE | ANTI-SEMI-JOIN |
| A, B | | LEFT OUTER JOIN |
| A, C | SYMMETRIC | ANTI-JOIN |
| | DIFFERENCE | |
| B, C | | RIGHT OUTER JOIN |
| A, B, C | UNION | SYMMETRIC OUTER |
| | | JOIN |

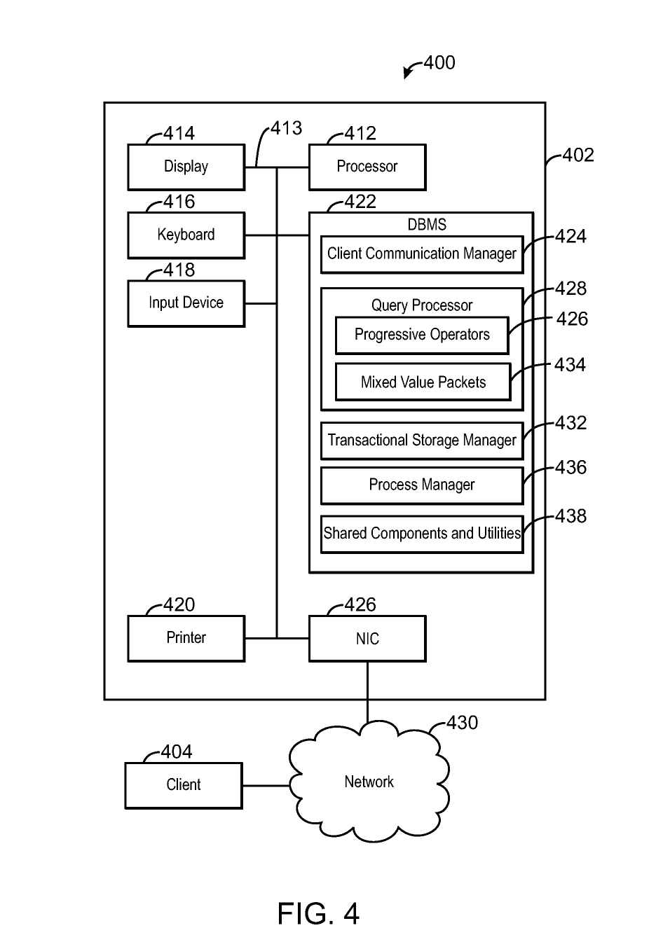

FIG. 4 is a block diagram of a system 400 adapted to generate query results according to an embodiment. The system is generally referred to by the reference number 400. Those of ordinary skill in the art will appreciate that the functional blocks and devices shown in FIG. 4 may comprise hardware elements including circuitry, software elements including computer code stored on a non-transitory, machine-readable medium or a combination of both hardware and software elements.

Additionally, the functional blocks and devices of the system 400 are but one example of functional blocks and devices that may be implemented in an embodiment. Those of ordinary skill in the art would readily be able to define specific functional blocks based on design considerations for a particular electronic device.

The system 400 may include a server 402 and a client 404, in communication over a network 430. The client 404 may submit a query 428 for processing, with the server 402 providing early results to the client 404. In one embodiment, the system 400 may include multiple servers 402, e.g., a massively parallel processing system, with one or more databases distributed across the multiple servers 402.

As shown in FIG. 4, the server 402 may include one or more processors 412 which may be connected through a bus 413 to a display 414, a keyboard 416, one or more input devices 418, and an output device, such as a printer 420. The input devices 418 may include devices such as a mouse or touch screen.

The server 402 may also be connected through the bus 413 to a network interface card (NIC) 426. The NIC 426 may connect the database server 402 to the network 430. The network 430 may be a local area network (LAN), a wide area network (WAN), such as the Internet, or another network configuration. The network 430 may include routers, switches, modems, or any other kind of interface device used for interconnection.

The server 402 may have other units operatively coupled to the processor 412 through the bus 413. These units may include non-transitory, machine-readable storage media, such as storage 422. The storage 422 may include media for the long-term storage of operating software and data, such as hard drives.

The storage 422 may also include other types of non-transitory, machine-readable media, such as read-only memory (ROM), random access memory (RAM), and cache memory. The storage 422 may include the software used in an embodiment.

The storage 422 may include a client communication manager 424, a process manager 436, shared components and utilities 438, progressive operators 426, the query processor 428, a transactional storage manager 432, and mixed value packets 434. The query processor 428 may execute a query plan that includes progressive operators 426 for generating early results.

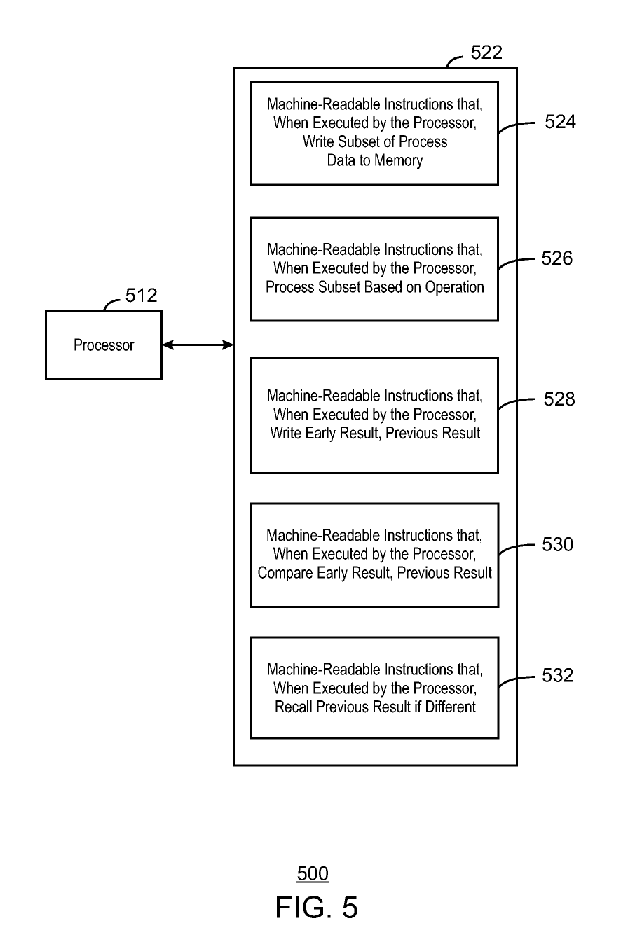

FIG. 5 is a block diagram showing a system 500 with a non-transitory, machine-readable medium that stores code adapted to query data streams according to an embodiment. The non-transitory, machine-readable medium is generally referred to by the reference number 522.

The non-transitory, machine-readable medium 522 may correspond to any typical storage device that stores computer-implemented instructions, such as programming code or the like. For example, the non-transitory, machine-readable medium 522 may include a storage device, such as the storage 422 described with reference to FIG. 4.

A processor 502 generally retrieves and executes the computer-implemented instructions stored in the non-transitory, machine-readable medium 522 to generate query results.

A region 524 may include instructions that write a subset of process data to memory. A region 526 may include instructions that process the subset based on an operation of a query.

A region 528 may include instructions that write early results to a priority queue. A region 530 may include instructions that compare the early results to a previous result. A region 532 may include instructions that recall a previous result, if different.

What is claimed is:

1. A method to generate progressive results for a sort operation, comprising:
writing a subset of an input to memory;
sorting the subset based on the query;
producing early results based on the sorted subset;
comparing the early results to previous results; and
recalling the previous results from a client of the sort operation.

2. The method recited in claim 1, comparing determining that a tuple of the sorted subset replaces a replaced tuple of the previous results.

3. The method recited in claim 1, comprising replacing the tuple.

4. The method recited in claim 2, comprising sending a message to a client, the message including the tuple and the replaced tuple.

5. The method recited in claim 4, wherein the replacement tuple comprises a sorted data column.

6. The method recited in claim 1, wherein the previous results comprise a queue in the memory, wherein, for the tuple, the queue comprises:
a unique identifier;
a sorted data column, based on the sort; and
a unique identifier for the replaced tuple.

7. The method recited in claim 1, wherein the sort operation specifies one of:
a sort statement;
a top statement; or
a join statement.

8. The method recited in claim 1, comprising writing a run based on the sorted subset.

9. The method recited in claim 8, wherein the method recited in claim 8 is repeated for all subsets of the input, and comprising performing an external merge of all the runs.

10. The method recited in claim 1, wherein the sort operation comprises a join operation.

11. The method recited in claim 10, wherein the join operation comprises one of:
an aggregation;
a user defined function; or
combinations thereof.

12. The method recited in claim 10, wherein the join is based on a mixed value packet that represents a single value packet comprising a plurality of tuples of a plurality of types.

13. The method recited in claim 12, comprising combining a plurality of mixed value packets in a sorted mixed stream.

14. The method recited in claim 13, comprising combining the plurality of mixed value packets in a sorted mixed stream during the creation of an index.

15. The method recited in claim 13, wherein the plurality of mixed value packets are used to produce and refine an early result from a join operation.

16. The method recited in claim 13, wherein the plurality of mixed value packets are used to produce and refine an early result from an aggregation operation.

17. A computer system for generating results for a sort operation comprising a top statement, comprising:
a memory; and
a processor, configured to:
write a subset of an input to memory;
sort the subset based on the sort operation;
produce early results based on the sorted subset;
compare the early results to previous results; and
recall the previous results from a client of the sort operation.

18. The computer system recited in claim 17, wherein the sort operation comprises a join operation comprising one of:
an aggregation;
a user defined function; or
combinations thereof.

19. The computer system recited in claim 18, wherein the join is based on a mixed value packet that represents a single value packet comprising a plurality of tuples of a plurality of types.

20. A non-transitory, computer-readable medium comprising machine-readable instructions executable by a processor for querying a data stream, the non-transitory, computer-readable medium comprising:
computer-readable instructions that, when executed by the processor, write a subset of an input to memory;
computer-readable instructions that, when executed by the processor, sort the subset based on the sort operation, wherein the sort operation comprises a join operation, wherein the join is based on a mixed value packet that represents a single value packet comprising a plurality of tuples of a plurality of types;
computer-readable instructions that, when executed by the processor, produce early results based on the sorted subset;
computer-readable instructions that, when executed by the processor, compare the early results to previous results;
computer-readable instructions that, when executed by the processor, recall the previous results from a client of the sort operation; and
computer-readable instructions that, when executed by the processor, combine a plurality of mixed value packets in a sorted mixed stream.
